(19) United States
(12) Patent Application Publication
(10) Pub. No.: US 2006/0077872 A1
(43) Pub. Date: Apr. 13, 2006

(54) Information recording medium, recording/reproducing apparatus, and recording/reproducing method

(75) Inventors: Sung-hee Hwang, Suwon-si (KR); Jung-wan Ko, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/204,358

(22) Filed: Aug. 16, 2005

(30) Foreign Application Priority Data
Aug. 27, 2004 (KR) 2004-68036

(51) Int. Cl. G11B 7/24; G11B 7/00

(52) U.S. Cl. 369/275.1; 369/275.3; 369/53.2

(57) ABSTRACT

A recording/reproducing apparatus a writing unit writes data to the information recording medium, which comprises a user data area for recording user data. A replacement recording block that replaces an original recording block recorded in the user data area is recorded in an unrecorded area of the user data area, the user data area is divided into at least one group, with each group including at least one R-zone. The recording/reproducing apparatus includes a controller that controls the writing unit to write the replacement block in an R-zone included in the same group as the group to which an R-zone where the original recording block is recorded belongs. Accordingly, the user data area is divided into several groups determined according to the characteristics of data to be recorded, and data is recorded in different groups of the user data area according to the type of data.

### CROSS-REFERENCE TO RELATED PATENT APPLICATION

This application claims the benefit of Korean Patent Application No. 2004-68036, filed on Aug. 27, 2004 in the Korean Intellectual Property Office, the disclosure of which is incorporated herein in its entirety by reference.

### BACKGROUND OF THE INVENTION

1. Field of the Invention

Aspects of the present invention relate to information recording media, and more particularly, to an information recording medium, a recording/reproducing apparatus, and a recording/reproducing method by which a user data area of the information recording medium can be efficiently managed.

2. Description of the Related Art

Rewritable information recording media generally include a spare area in a portion of a data area to achieve defect management. In other words, when defective data is detected while user data is being recorded in a user data area (an area left by excluding the spare area from the data area) or while data recorded in the user data area is being reproduced, a replacement of the defective data is recorded in the spare area.

In write-once information recording media, such defect management method is applied to logical overwrite (LOW). Logical overwrite is used to make write-once information recording media behave like rewritable information recording media. In other words, to update data already recorded in a user data area of a write-once medium, the recorded data is treated as defective data, and a replacement of the recorded data is recorded in the spare area. Accordingly, the logical address of the data already recorded in the user data area is still used as the logical address of the replacement data, although the physical address of the replacement data is different from the physical address of the already-recorded data. Hence, a host can detect that the data already recorded in the user data area was overwritten, because the host accesses only a logical address. Thus, the host can easily manage the write-once information recording media.

However, a method of recording update data in an unrecorded area of a user data area instead of a spare area and providing replacement information (i.e., defect entry information) has been used to achieve LOW based on defect management to fully utilize the capacity of a write-once information recording medium. An example of the method of recording update data in an unrecorded area of a user data area instead of a spare area will now be described with reference to FIGS. 1A and 1B.

FIGS. 1A and 1B are reference diagrams to explain a gap between a logical volume space and a physical volume space in the conventional art. Referring to FIG. 1A, a data area of an information recording medium includes a spare area (SA), a user data area, and a spare area (SA) which are sequentially allocated. Data A is recorded in a start address of the user data area. Then, to update data A already recorded in the user data area to perform LOW, as shown in FIG. 1B, an update of data A is recorded next to the data A. As such, a replacement of data recorded in the user data area is recorded in an unrecorded area of the user data area. Hence, the physical volume space is recorded with data A and the update of data A, and the logical volume space is recorded with the update of data A.

In a sequential recording mode where data is sequentially recorded in a plurality of areas into which a user data area is divided, like an R-zone of a DVD or a track of a CD, data is recorded in each of the divided areas at a host's command. As described above, a host sends commands to a drive system so that a user data area of an information recording medium is divided into a plurality of subareas. The data is recorded in a way desired by the host, for example, in such a way that file system data are recorded in some subareas and user data are recorded in subareas other than the subareas recorded with the file system data. Hence, the host can efficiently manage the user data area of the information recording medium in accordance with the host's purpose. However, since a replacement of data already recorded in the user data area to achieve LOW can be recorded in the user data area, a drive system can write data to each of the subareas of the user data area.

Because the drive system cannot recognize whether data recorded in each of the subareas is either user data or file system data, which is used to manage the user data, the drive system may record the replacement upon LOW in an unrecorded area of each of the subareas regardless of a user's intension, that is, without distinguishing between the areas for user data and the areas for file system data. Hence, an arrangement of data recorded in the logical volume space, which is managed by the host, is very different from that recorded in the physical volume space, namely, actually recorded in the information recording medium. Thus, it is difficult to manage the user data area of the information recording medium in accordance with the host's intention, and the efficiency of recording/reproducing data is degraded.

### SUMMARY OF THE INVENTION

Aspects of the present invention provide an information recording medium, a recording/reproducing apparatus, and a recording/reproducing method by which a user data area of the information recording medium can be efficiently used in a system where recording of replacement data according to logical overwriting (LOW) occurs in any of a spare area and the user data area.

According to an aspect of the present invention, there is provided an information recording medium comprising a user data area for recording user data, wherein a replacement recording block that replaces an original recording block recorded in the user data area is recorded in an unrecorded area of the user data area, the user data area is divided into at least one group, each group including at least one R-zone, and the replacement recording block is recorded in an R-zone included in the same group as the group having an R-zone where the original recording block is recorded.

According to an aspect of the present invention, the at least one group includes a group for recording user data and a group for recording file system data.

According to an aspect of the present invention, recording management data (RMD) used to manage the recording of data in the information recording medium is included

According to an aspect of the present invention, the recording management data (RMD) includes an RMD header that contains information about the groups and at least one R-zone entry that contains information about the R-zones.

According to an aspect of the present invention, the RMD header includes at least one of information about the number of groups, information about the number of R-zones for each group, information about the number of open R-zones for each group, and a list of R-zone entries for each group.

According to an aspect of the present invention, each of the R-zone entries includes information about a group designated to each of the R-zones.

According to an aspect of the present invention, the recording block includes a data part that contains original data or replacement data and an additional information part that contains additional information about the original data or the replacement data.

According to an aspect of the present invention, the additional information part contains group information about a group to which the recording block belongs.

According to another aspect of the present invention, there is provided a recording apparatus comprising: a writing unit writing data to an information recording medium that comprises a user data area for recording user data, wherein a replacement recording block that replaces an original recording block recorded in the user data area is recorded in an unrecorded area of the user data area, and the user data area is divided into at least one group, with each group including at least one R-zone; and a controller controlling the writing unit to write the replacement recording block in an R-zone included in the same group as the group including an R-zone where the original recording block is recorded.

According to another aspect of the present invention, there is provided a reproducing apparatus comprising: a reading unit reading data from an information recording medium that comprises a user data area for recording user data, wherein a replacement recording block that replaces an original recording block recorded in the user data area is recorded in an unrecorded area of the user data area and the user data area is divided into at least one group, with each group including at least one R-zone; and a controller controlling the reading unit to read the replacement recording block from an R-zone included in the same group as the group to which an R-zone where the original recording block is recorded belongs.

According to another aspect of the present invention, there is provided a method of recording data in an information recording medium that comprises a user data area for recording user data, wherein a replacement recording block that replaces an original recording block recorded in the user data area is recorded in an unrecorded area of the user data area, and the user data area is divided into at least one group, with each group including at least one R-zone, the method comprising writing the replacement recording block in an R-zone included in the same group as the group which includes an R-zone where the original recording block is recorded.

According to another aspect of the present invention, there is provided a method of reproducing data from an information recording medium that comprises a user data area for recording user data, wherein a replacement recording block that replaces an original recording block recorded in the user data area is recorded in an unrecorded area of the user data area, and the user data area is divided into at least one group, with each group including at least one R-zone, the method comprising reading the replacement recording block from an R-zone included in the same group as the group having an R-zone where the original recording block is recorded.

Additional aspects and/or advantages of the invention will be set forth in part in the description which follows and, in part, will be obvious from the description, or may be learned by practice of the invention.

### BRIEF DESCRIPTION OF THE DRAWINGS

The above and other features and/or advantages of the present invention will become more apparent and more readily appreciated by describing in detail exemplary embodiments thereof with reference to the accompanying drawings in which:

FIGS. 1A and 1B are reference diagrams to explain the concept of logical overwrite (LOW) according to a conventional art in which replacement data is recorded in a user data area;

FIG. 2 is a schematic block diagram of a recording/reproducing apparatus according to an embodiment of the present invention;

FIG. 3 is a detailed block diagram of an example of the recording/reproducing apparatus of FIG. 2;

FIG. 4 is a block diagram of an embodiment of a structure of an information recording medium used in the recording/reproducing apparatus of FIG. 2;

FIG. 5 illustrates an embodiment of a data structure of a replacement entry shown in FIG. 4;

FIG. 6 illustrates an embodiment of a data structure of record management data (RMD) shown in FIG. 4;

FIG. 7 illustrates an embodiment of the data structure of the RMD shown in FIG. 4;

FIG. 8 illustrates an embodiment of a detailed field structure of an R-zone entry shown in FIG. 7;

FIG. 9A illustrates a status of an information storage medium that has undergone first data recording according to an embodiment of the present invention;

FIG. 9B illustrates a status of an information storage medium that has undergone second data recording according to an embodiment of the present invention;

FIG. 9C illustrates a status of an information storage medium that has undergone third data recording according to an embodiment of the present invention;

FIGS. 10A through 10C illustrate an RMD before and after the first data recording of FIG. 9A;

FIGS. 11A through 11C illustrate an RMD before and after the second data recording of FIG. 9B;

FIGS. 12A through 12C illustrate an RMD before and after the third data recording of FIG. 9C;

FIG. 13 is a flowchart illustrating a method of recording data, according to an embodiment of the present invention;

FIG. 14 is a block diagram of a structure of a block which is recorded/reproduced as a unit in/from a user data area of the information recording medium shown in FIG. 4;

FIG. 15 illustrates a structure of an information recording medium on which blocks has been recorded, according to an embodiment of the present invention;

FIG. 16 is a block diagram of structures of replacement entries produced based on the recorded blocks illustrated in FIG. 15; and

FIGS. 17A and 17B are block diagrams of structures of replacement entries recovered based on the recorded blocks illustrated in FIG. 15.

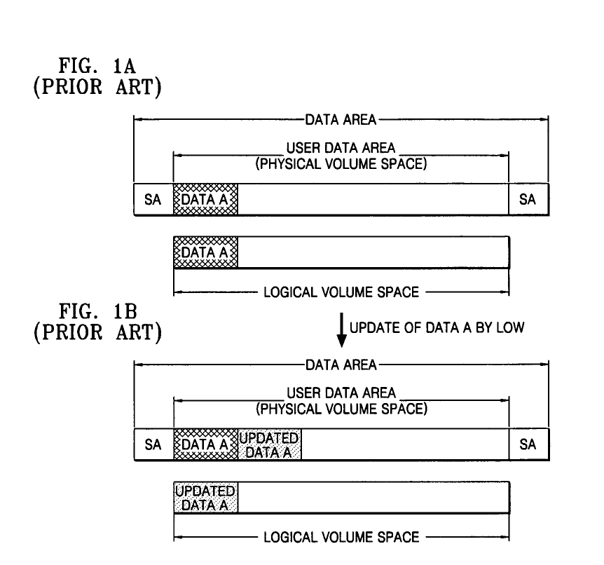

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

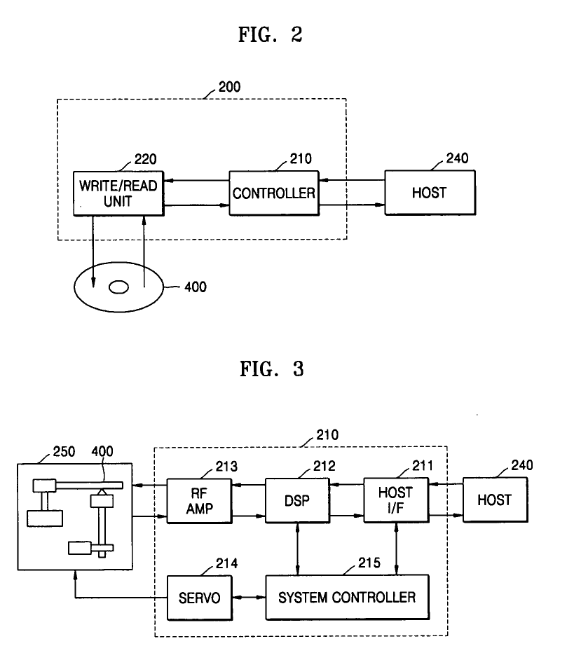

FIG. 2 is a schematic block diagram of a recording/reproducing apparatus 200 according to an embodiment of the present invention. Referring to FIG. 2, the recording/reproducing apparatus 200 includes a write/read unit 220 and a controller 210. The write/read unit 220 writes data to an information recording medium 400 according to an aspect of the present embodiment, under the control of the controller 210 and reads out written data to reproduce the written data. The controller 210 controls the write/read unit 220 to write/read data in a recording unit block or obtains effective data by processing data read by the write/read unit 220. While not required, it is understood that the host 240 need not be external to the apparatus 200 and can be integrated into the apparatus, such as in a stand alone player and/or computer with integrated drive.

Upon writing, the controller 210 controls the write/read unit 220 to perform logical overwriting (LOW) according to a command of a host 240 or under the control of the recording/reproducing apparatus 200. When a defective block is detected through verification during or after data recording, the controller 210 controls the write/read unit 220 to write a replacement block of the defective block in a spare area of a user data area of the information recording medium 400. LOW denotes a technique in which to update data recorded in a user data area included in a data area of a write-once recording medium. The update data, namely, replacement data, is recorded in a spare area included in the data area or in an unrecorded area of the user data area. Information about the addresses of the original data and the replacement data is so managed that a host 240 cannot recognize any change to a logical address. As described above, the controller 210 performs replacement to achieve LOW and replacement to remove defective data. Particularly, in an aspect of the present invention, the controller 210 controls the write/read unit 220 to classify data to be written to the user data area according to data characteristics. For example, file system data are classified into group 0, and user data are classified into group 1. Furthermore, the controller 210 controls the write/read unit 220 to insert information about the groups into a block that is written as a unit to the user data area. This block is hereinafter referred to as a recording unit block. The recording of the group information helps data recovery.

FIG. 3 is a detailed block diagram of an embodiment of the recording/reproducing apparatus 200 of FIG. 2. Referring to FIG. 3, the recording/reproducing apparatus 200 (e.g., a disc drive) includes a pickup 250, which serves as the write/read unit 220. The information storage medium 400 is installed on the pickup 250. The disc drive includes a host interface (I/F) 211, a DSP 212, an RF AMP 213, a servo 214, and a system controller 215, which serve as the controller 210.

Upon writing, the host I/F 211 receives to-be-written data and a write command together with information about a logical address of the to-be-written data from the host 240 and transmits the received data, command, and information to the system controller 215. The system controller 215 receives the write command from the host I/F 211 and performs an initialization necessary for the writing. The DSP 212 adds additional data, such as, parity, to the to-be-written data received from the host I/F 211 to achieve error correction, performs ECC (error correction code) encoding on the resultant to-be-written data to produce an error-corrected block (namely, an ECC block), and modulates the ECC block in a predetermined scheme. The RF AMP 213 converts the modulated EEC block data output from the DSP 212 into an RF signal. The pickup 250 receives the RF signal from the RF AMP 213 and writes the same to the information storage medium 400. The servo 214 receives a command necessary for servo control from the system controller 215 and servo-controls the pickup 250.

In particular, the shown system controller 215 receives a command to allocate R-zones where data are recorded from the host 240, partitions the user data area into the R-zones, and assigns a group to each of the R-zones. In response to a data recording command of the host 240, the system controller 215 controls the pickup 250 to write data to an R-zone to which a group into which the data is classified is assigned, to produce record management data (RMD) that indicates a status of this recording, and to write the RMD to the information recording medium 400. In addition, the system controller 215 controls the pickup 250 to insert group information into a recording unit block to be written to the user data area and then write the block including the group information to the user data area.

During reproduction, the host I/F 211 receives a data read command from the host 240. The system controller 215 performs an initialization necessary for the reading. The pickup 250 radiates a laser beam onto the information storage medium 400, receives a laser beam reflected by the information storage medium 400, and outputs an optical signal obtained from the received laser beam. The RF AMP 213 converts the optical signal received from the pickup 250 into the RF signal and provides modulated data extracted from the RF signal to the DSP 212 and a servo control signal extracted from the RF signal to the servo 214. The DSP 212 demodulates the modulated data, performs ECC on the demodulated data, and outputs resultant data. The servo 214 receives the servo signal from the RF AMP 213 and the command necessary for servo control from the system controller 215 and servo-controls the pickup 250. The host I/F 211 transmits the data output from the DSP 212 to the host 240.

In particular, the system controller 215 converts a logical address of data indicated by the data read command into a physical address, searches for a replacement address from a defect entry based on the physical address, and reads data recorded in the replacement address. At this time, only the R-zones belonging to a group associated with the type of the data to be read are accessed, so the data can be read out fast. Also, when recovering a replacement entry and RMD, the system controller 215 can recover the replacement entry and RMD by reading only a recording unit block having information about a group corresponding to data to be recovered by referring to additional information contained in the recording unit block. Thus, the replacement entry and RMD can be rapidly recovered.

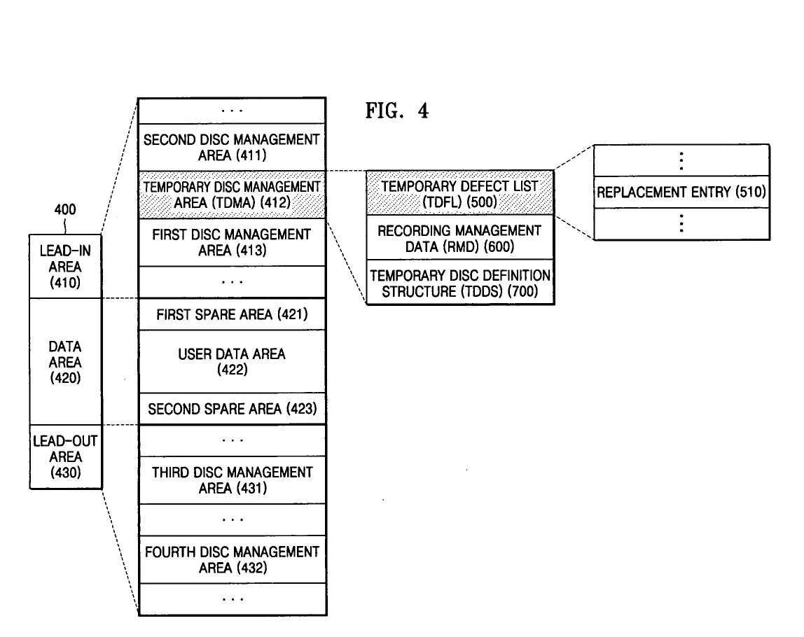

FIG. 4 is a block diagram illustrating a structure of the information recording medium 400 according to an aspect of the invention. Referring to FIG. 4, the information recording medium 400 includes a lead-in area 410, a data area 420, and a lead-out area 430 that are sequentially arranged. The lead-in area 410 includes a second disc management area 411, a temporary disc management area (TDMA) 412, a first disc management area 413, etc.

The TDMA 412 denotes an area for storing information used for both temporary defect management and temporary disc management which are usually required to manage a write-once information recording medium. The TDMA 412 stores a temporary defect list (TDFL) 500 as temporary defect information, recording management data (RMD) 600, and a temporary disc definition structure (TDDS) 700 as temporary defect management information.

The TDFL 500 denotes information about a status of the information recording medium 400 on which replacement upon defect generation or replacement for LOW has occurred. The TDFL 500 includes information about a location of defective data and information about a location of replacement of the defective data. In particular, the TDFL 500 includes a replacement entry 510.

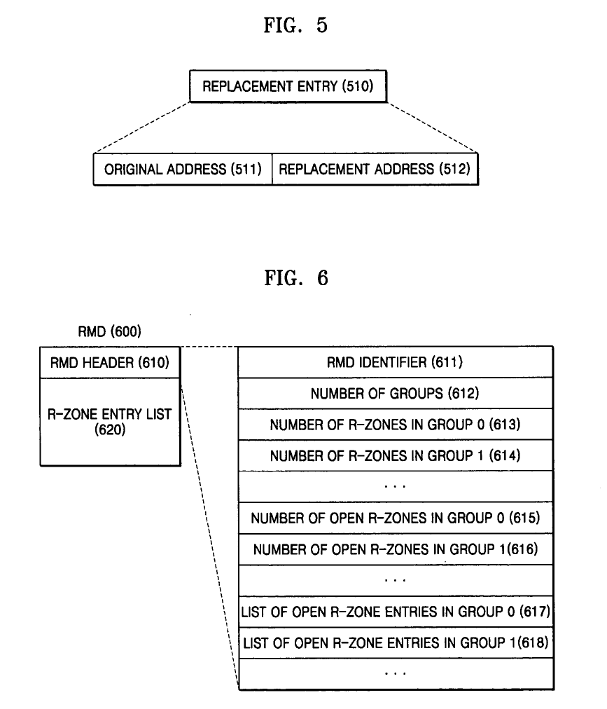

FIG. 5 illustrates a data structure of the replacement entry 510. Referring to FIG. 5, the replacement entry 510 includes an original address 511 and a replacement address 512. The original address 511 denotes a start sector address of an original recording block, and the replacement address 512 denotes a start sector address of a replacement recording block. This is because a drive system 200 replaces data in units of a block, which is a unit in which data is recorded/reproduced. Thus, the drive system 200 represents a status of the replacement as a block of replacement data.

When the user data area 422 is used according to a sequential recording mode, the RMD 600 includes as entry information a status of a user data area 422 on which data is recorded. The RMD 600 will be described in greater detail with reference to FIGS. 6 through 8.

The TDDS 700 includes location pointers of the temporary defect information 500, the RMD 600, and a drive area (not shown), information about locations and sizes of first and second spare areas 421 and 423 allocated upon initialization, write-protection information, information about a location and a size of the temporary disc management area 412, information about a user data area 422, information about locations of portions of the first and second spare areas 421 and 423 where replacement data can be written, information about a last address in the user data area 422 where data is written, etc.

The first disc management area 413, the second disc management area 411, a third disc management area 431, and a fourth disc management area 432 are allocated to record final temporary disc management information when the write-once information recording medium 400 is finalized. While not required, it is understood that other numbers of management areas 411, 413, 431, 432 can be used.

The data area 420 includes the first spare area 421, the user data area 422, and the second spare area 423, which are sequentially arranged in the shown embodiment. The first and second spare areas 421 and 423 are allocated to record replacement data (that is, data that replaces data recorded in defective areas of the user data area 422). The first and second spare areas 421 and 423 may store replacement data that replaces defective data or replacement data that replaces user data to achieve LOW. It is understood that fewer or more numbers of areas 421, 423 can be used, and/or the areas can be located in other portions of the data area 422.

The user data area 422 denotes an area where user data is recorded. Replacement data that replaces user data to achieve LOW can be recorded in the user data area 422 instead of the spare area 421 or 423. In particular, the user data area 422 is divided into at least one R-zone, to each of which a group is assigned. For example, if the host 240 plans to group R-zones of the user data area into an area where file system data is recorded and an area where user data is recorded, each of the R-zones is assigned one of the two groups to match with the characteristics of data set to be recorded in the corresponding R-zone. Accordingly, when the host 240 is to reproduce only file system data, the desired file system data can be sufficiently reproduced by accessing only R-zones grouped to store file system data. Consequently, there is no need to access all of the R-zones of the user data area.

A data format of recording management data (RMD) 600 is described below. The RMD 600, which is used to manage the recording of data in a user data area of an information recording medium, has at least two R-zone groups. Each R-zone group including one R-zone or a plurality of R-zones. For example, the RMD 600 may have two R-zone groups. One group is for recording file system data, which includes a volume structure and a file structure used to manage general user data recorded on the information recording medium, and recording a replacement of the file system data to achieve LOW. The other group is for recording general user data and recording a replacement of the user data to achieve LOW. Accordingly, the header of the RMD 600 partially varies.

In general, the header of RMD 600 includes the number of entries of all R-zones, the number of open R-zones, a list of the entries of the open R-zones, etc.

An open R-zone denotes an R-zone that is able to store additional data, and a closed R-zone denotes an R-zone that is unable to store additional data. When the host 240 wants to add data, the additional data is to be written to an open R-zone, so the number of open R-zones and the list of open R-zone entries are needed to inform a host of open R-zones.

However, when replacement data upon LOW is allowed to be written to the user data area 422 (that is, R-zones), and the user data area 422 is divided into two groups, if the host 240 wants to add data to the user data area 422, the host 240 should know whether open R zones exist within a R-zone group where the data is to be written. If open R zones exist within the R-zone group where the data is to be written, the host 240 should know what open R-zones are included in the group. Upon replacement according to LOW, the drive system 200 must record replacement data in an open R-zone included in the group where the original data is stored. Hence, the number of open R-zones in each group and a list of R-zone entries for each group are included in the header of RMD 600 in an aspect of the invention. The header further includes the number of R-zone groups.

FIG. 6 is a block diagram of a data structure of the RMD 600 of FIG. 4. Referring to FIG. 6, the RMD 600 includes an RMD header 610, which includes information about groups into which the user data area is divided. The RMD 600 has a list 620 of R-zone entries, which indicates information about R-zones of the user data area. The RMD header 610 includes an RMD identifier 611, the number 612 of groups into which the user data area 422 is divided, the number 613 of R-zones in group 0, the number 614 of R-zones in group 1, the number 615 of open R-zones in group 0, the number 616 of open R-zones in group 1, a list 617 of entries of the open R-zones in group 0, and a list 618 of entries of the open R-zones in group 1. The list of open R-zone entries in group 0 or 1 indicates, for examples, the numbers of the open R-zone entries in group 0 or 1 so as to indicate to the host 240 which zones are available to receive data of a type associated with a corresponding group. While shown in terms of 2 groups, it is understood that other numbers of groups can be used.

FIG. 7 illustrates the data structure of the list 620 of the RMD 600 shown in FIG. 6. Referring to FIG. 7, the R-zone entry list 620 includes a first R-zone entry 621, a second R-zone entry 622, a third R-zone entry 623, a fourth R-zone entry 624, . . . Each R-zone entry 621, 622, 623, 624 denotes information about each corresponding R-zone.

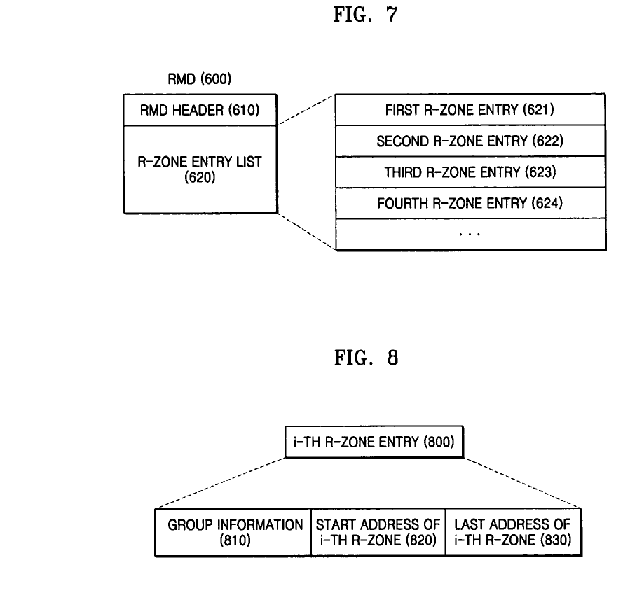

A detailed field structure of an i-th R-zone entry 800 is shown in FIG. 8. Referring to FIG. 8, an i-th R-zone entry 800 includes group information 810, which indicates a group (i.e., Group 0 or Group 1) into which an i-th R-zone is classified. The i-th R-zone entry 800 includes a start address 820 of the i-th R-zone, and a last address 830 of the i-th R-zone that is recorded with data.

The group information 810 indicates the group to which each of the R-zones belongs. When the drive system 200 needs to perform replacement for LOW in response to a recording command of a host, a location of replacement data to be recorded is limited to an R-zone group in which the original data has been recorded. In other words, in the shown example, there are group 0 including R-zones having group information 810 “0” and group 1 including R-zones having group information 810 “1”. When the host 240 issues a command to record replacement data in an R-zone included in group “0” and the physical address corresponding to the logical address of the R-zone is already recorded with the data, the drive system 200 records the replacement data in only R-zones having the same group information as that of the R-zone indicated by the host's 240 recording command. That is, the R-zone where the replacement data is stored is included in the same group as that of the R-zone where the original data is stored.

More specifically, the group information 810 is state information of the R-zone entry 800 indicating whether each R-zone belongs to a group associated with file system data or user data. The 200 can store replacement data in only an R-zone belonging to a group associated with the original data. Consequently, file system data and user data exist in different R-zone groups which are distinguished from each other using the group information 810.

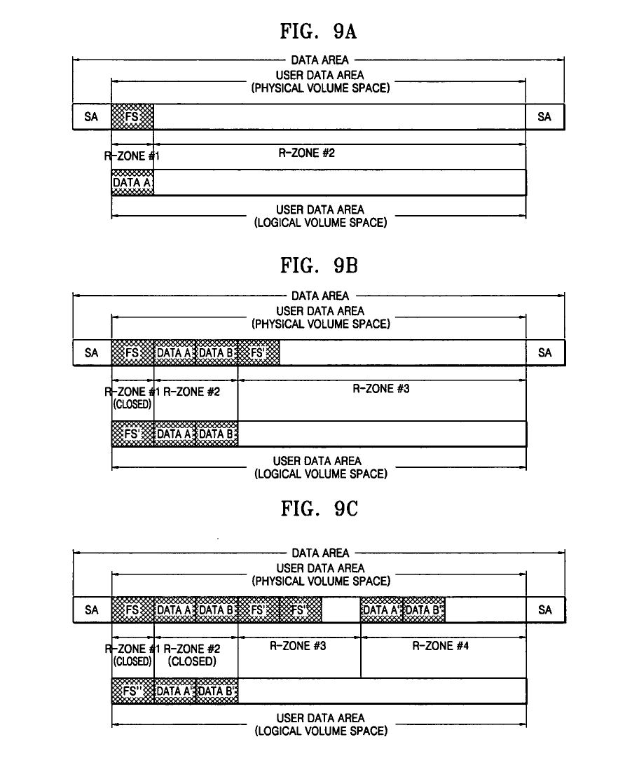

FIG. 9A illustrates a status of an information storage medium after first data recording according to an embodiment of the present invention. FIG. 9B illustrates a status of the information storage medium after second data recording. FIG. 9C illustrates a status of the information storage medium after third data recording.

Referring to FIG. 9A, to use the information recording medium according to a sequential recording mode, a user data area of the information recording medium is divided into two R-zones: R-zone #1 and R-zone #2, upon initialization in response to a command of the host 240 or the drive system 200. R-zone #1 is set to belong to group 0 to record file system data, and R-zone #2 is set to belong to group 1 to record user data. Then, initialized file system data FS is recorded in R-zone #1, and R-zone #1 is closed because more data cannot be recorded in R-zone #1.

Referring to FIG. 9B, when user data is recorded after the first recording illustrated in FIG. 9A, the initialized file system data FS must be updated. Then, replacement data FS′ that replaces the initialized file system FS to achieve LOW must be recorded in an R-zone belonging to the same group as the group of R-zone #1. Hence, R-zone #2 of FIG. 9A is divided into R-zone #2 and R-zone #3 as shown in FIG. 9B. Data A and data B are recorded in R-zone #2, and R-zone #2 is closed because there is no room to store more data. Because the initialized file system data FS must be updated due to the addition of data B, the replacement data FS′ of the initialized file system must be recorded in R-zone #3. When R-zone #3 is allocated, it is already set to belong to group 0. Hence, upon updating of the initialized file system data FS, when the host issues a command to record the replacement data FS′ in the logical address (i.e., R-zone #1) of the initialized file system data FS, the drive system 200 detects that the physical address (i.e., R-zone #1) corresponding to the logical address indicated by the command is already recorded with data and checks as to which group the physical address (R-zone #1) belongs. Then, the drive system 200 records the replacement data FS′ in an R-zone included in the same group as that of R-zone #1 where the initialized file system data FS is recorded, that is, R-zone #3. Of course, the drive system 200 produces a replacement entry indicating the status of this replacement and manages the replacement entry as TDFL.

Referring to FIG. 9C, when an update of data A and data B recorded in R-zone #2 is required after second recording of FIG. 9B, R-zone #4 is allocated as group 1 in response to a command of the host or the drive system 200 to secure an R-zone where replacement data A′ and data B′ are to be recorded. When the host 240 issues a command to record the replacement data A′ and data B′ in the logical address (i.e., R-zone #2) of the data A and B, the drive system 200 detects that the physical address (i.e., R-zone #2) corresponding to the logical address indicated by the command is already recorded with data and that an open R-zone belonging to group 1, which is the group to which the physical address (R-zone #2) of the data A and B belongs, is R-zone #4. Then, the drive system 200 records the replacement data A′ and data B′ in R-zone #4. When the host 240 issues a command to record data FS″ in the logical address (R-zone #1) of data FS′ to update data FS′, the drive system 200 records data FS″ in R-zone #3 as shown in FIG. 9C by knowing that the physical address (i.e., R-zone #1) corresponding to the logical address indicated by the command is already recorded with data and that an open R-zone belonging to group 0, which is the group to which the physical address (R-zone #1) belongs, is R-zone #3. Of course, the drive system 200 produces replacement entry indicating the status of this replacement and manages the replacement entry as TDFL.

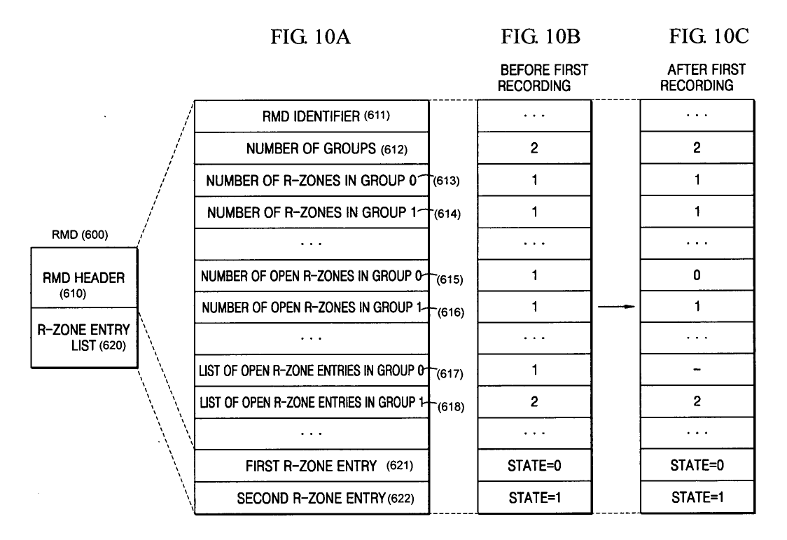

RMD formats after and before each of the first data recording of FIG. 9A, the second data recording of FIG. 9B, and the third data recording of FIG. 9C will now be described using FIGS. 10A through 12C.

FIGS. 10A through 10C illustrate the RMD 600 before and after the first data recording of FIG. 9A. Referring to FIGS. 10A through 10C, FIG. 10A shows fields of RMD 600, FIG. 10B shows values of the fields of RMD 600 before the first data recording, and FIG. 10C shows values of the fields of RMD 600 after the first data recording.

The user data area of the information recording medium of FIG. 9A is divided into two groups: group 0 and group 1. Each of the groups includes one R-zone as shown in FIG. 10B. Before the first data recording, the R-zones of group 0 and group 1 are both open. After the first data recording, R-zone #1 is closed due to the recording of file system data FS. The status value of an R-zone entry for each R-zone indicates a group to which each R-zone belongs.

More specifically, the number of R-zones for group 0 and that for group 1 are both 1 in the RMD 600 before the first data recording, and the number of R-zones for group 0 and for group 1 are also both 1 in the RMD 600 after the first data recording. In the RMD 600 before the first data recording, the number of open R-zones for group 0 is 1, and the number of open R-zones for group 1 is also 1. However, in the RMD 600 after the first data recording shown in FIG. 10C, the number of open R-zones for group 0 is changed to 0.

In the RMD 600 before the first data recording as shown in FIG. 10B, the field for an open R-zone list for group 0 is filled with 1, which is the number of an entry of the single open R-zone for group 0, and the field for an open R-zone list for group 1 is filled with 2, which is the number of an entry of the single open R-zone for group 1. In the RMD 600 after the first data recording as shown in FIG. 10C, since no open R-zones exist in group 0 after the second data recording, the field for the open R-zone list for group 0 is empty.

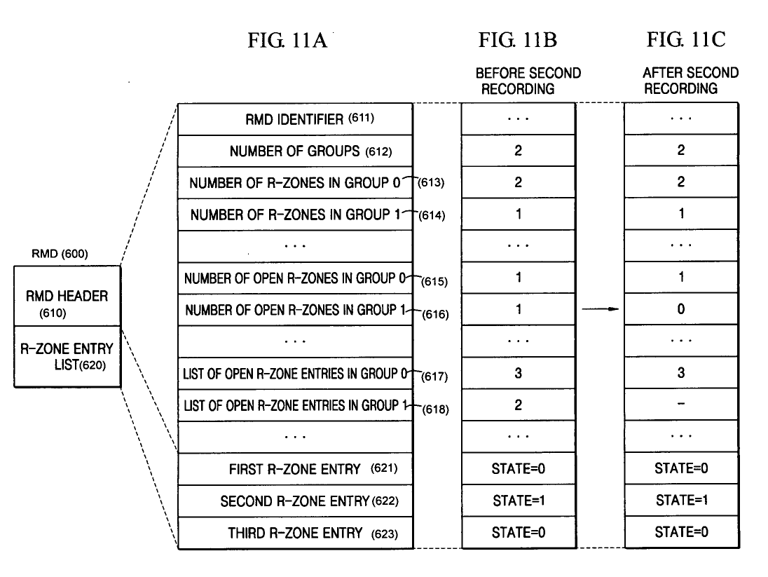

FIGS. 11A through 11C illustrate RMD 600 before and after the second data recording of FIG. 9B. Referring to FIGS. 11A through 11C, FIG. 11A shows fields of RMD 600, FIG. 11B shows values of the fields of RMD 600 before the second data recording, and FIG. 11C shows values of the fields of RMD 600 after the second data recording.

The user data area of the information recording medium of FIG. 9B is divided into two groups: group 0 and group 1. Group 0 includes two R-zones: R-zone #1 and R-zone #3. Group 1 includes a single R-zone: R-zone #2. Before the second data recording, R-zones #2 and #3 are both open as indicated in FIG. 11B. After the second data recording, R-zone #2 is closed due to the recording of data A and data B as indicated in FIG. 11C. The status value of an R-zone entry for each R-zone indicates a group to which each R-zone belongs.

More specifically, the number of R-zones for group 0 is 2 and the number of R-zones for group 1 is 1. Before the second data recording and after the second data recording, the number of R-zones for group 0 is 2 and the number of R-zones for Group 1 is 1. In the RMD 600 before the second data recording, the number of open R-zones for group 0 is 1, and the number of open R-zones for group 1 is also 1. However, the R-zone in group 1 is closed due to the second data recording, so the number of open R-zones for group 0 in the RMD 600 after the second data recording is changed to 0. In the RMD 600 before the second data recording, the field for an open R-zone list for group 0 is filled with 3, which is the number of an entry of the single open R-zone for group 0. The field for an open R-zone list for group 1 is filled with 2, which is the number of an entry of the single open R-zone for group 1. In the RMD 600 after the second data recording, since no open R-zones exist in group 1 after the second data recording, the field for the open R-zone list for group 1 is empty.

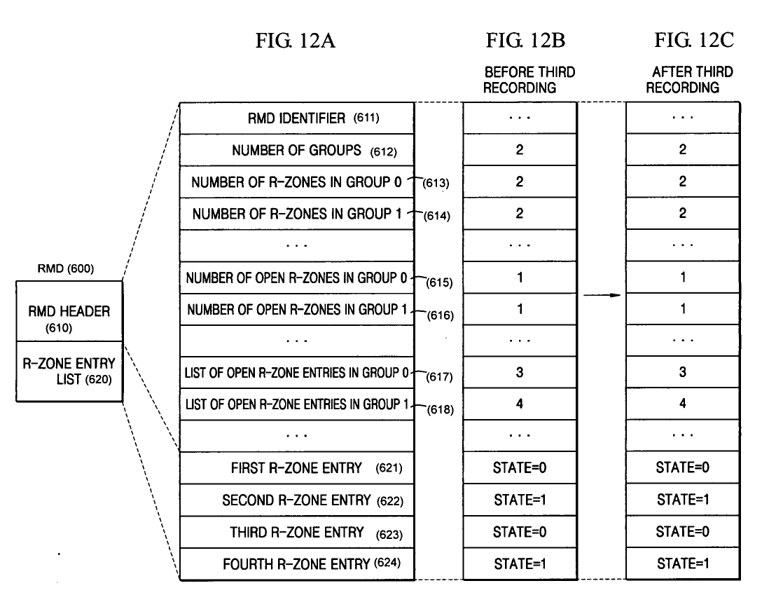

FIGS. 12A through 12C illustrate RMD 600 before and after the third data recording of FIG. 9C. Referring to FIGS. 12A through 12C, FIG. 12A shows fields of RMD 600, FIG. 12B shows values of the fields of RMD 600 before the third data recording, and FIG. 12C shows values of the fields of RMD 600 after the third data recording.

The user data area of the information recording medium of FIG. 9C is divided into two groups: group 0 and group 1. Group 0 includes two R-zones, namely, R-zone #1 and R-zone #3. Group 1 includes two R-zones: R-zone #2 and R-zone #4. Before and after the third data recording, R-zones #3 and #4 are both open. The status value of an R-zone entry for each R-zone indicates a group to which each R-zone belongs.

More specifically, the number of R-zones for group 0 and that for group 1 are both 2 in the RMDs 600 before and after the third data recording as shown in FIGS. 12B and 12C. In the RMDs 600 before and after the third data recording, the number of open R-zones for group 0 and the number of open R-zones for group 1 are both 1. In the RMDs before and after the third data recording, the field for an open R-zone list for group 0 is filled with 3, which is the number of an entry of the single open R-zone for group 0, and the field for an open R-zone list for group 1 is filled with 4, which is the number of an entry of the single open R-zone for group 1.

As described above, the host 240 or the drive system 200 can rapidly ascertain the R-zones required by each group by referring to the number of R-zones for each group. The host 240 or drive system 200 can also ascertain the number of open R-zones for each group, and an open R-zone entry list for each group that are included in the header of RMD while using the information recording medium. As needed, the host 240 or the drive system 200 can allocate additional R-zones if an insufficient number of open R-zones exist for a particular group.

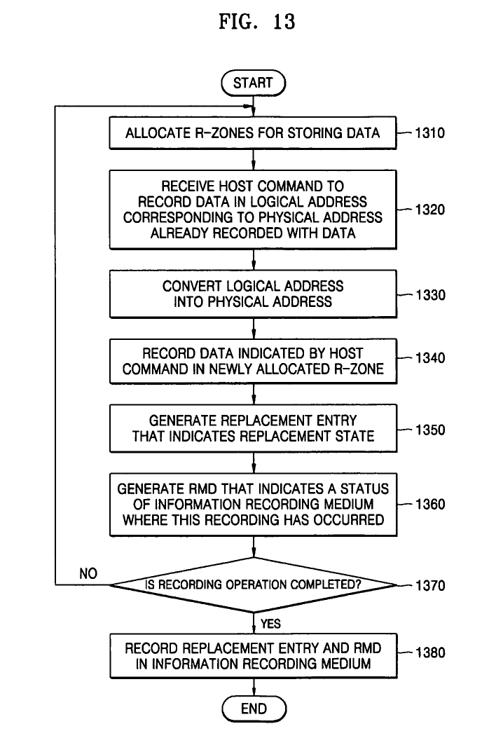

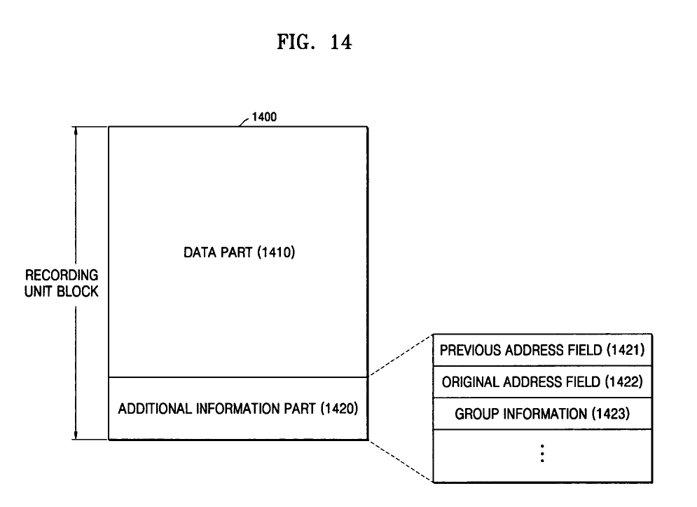

FIG. 13 is a flowchart illustrating a method of recording data, according to an embodiment of the present invention. In operation 1310, R-zones for storing data are allocated before a data recording command is actually issued. The allocation of the R-zones may be performed in response to a command of a host or under the control of the drive system 200, but can be otherwise performed before receipt at the host or drive system. In general, the drive system 200 allocates R-zones in response to the command of the host 240. Upon the R-zone allocation, each of the allocated R-zones is assigned any of groups defined according to the characteristics of data to be recorded. For example, an R-zone allocated to store file system data is set to be group 0. However, it is understood that other numbers can be used, and that other types of groups can be used. For instance, additional groups could be assigned to distinguish audio data from video data and/or computer files.

In operation 1320, the drive system 200 receives from the host 240 a command to record data in a logical address corresponding to a physical address in which data is already recorded. In operation 1330, the drive system 200 converts the logical address into a physical address. In operation 1340, the data indicated by the command of the host 240 is recorded in a newly allocated R-zone for the data type. In operation 1350, the drive system 200 generates a replacement entry that indicates the recording status. In operation 1360, the drive system 200 generates an RMD 600 that indicates a status of the information recording medium where this recording has occurred.

In operation 1370, the drive system 200 determines whether a recording operation is completed. The replacement entry and the RMD 600 may be recorded in the information recording medium in units of any operation. For example, the replacement entry and the RMD 600 may be recorded in the information recording medium every time the recording operation is completed.

In operation 1380, when the recording operation is completed, the drive system 200 records the replacement entry and the RMD 600 in the information recording medium. When the recording operation is not completed, the method proceeds to operation 1310 to perform next data recording.

Group information as described above is inserted into a recording unit block, and the recording unit block with the group information is recorded. Hence, the group information can be used to recover RMD 600 or a replacement entry when reproduction of the RMD 600 or the replacement entry fails.

FIG. 14 is a block diagram of an embodiment of a structure of a recording unit block 400 recorded in the user data area 422 of the information recording medium shown in FIG. 4. Referring to FIG. 14, the recording unit block 400 includes a data part 1410 and an additional information part 1420. The data part 1410 is user data. If the recording unit block 1400 is an original recording block, the data part 1410 is original data that is initially recorded. If the recording unit block 1400 is a replacement recording block, the data part 1410 is replacement data.

The additional information part 1420 is additional information about the original data or the replacement data. The additional information part 1420 includes a previous address 1421, an original address 1422, and group information 1423. The original address field 1422 records an address representing a location of an original recording block that is initially recorded. The previous address field 1421 records an address representing a location of an immediately previous block, which is replaced by the recording unit block 1400. The group information 1423 denotes information about a group to which the recording unit block 1400 belongs. As such, when a recording unit block includes group information about a group to which the recording unit block belongs, it can be known to which groups blocks recorded in the information recording medium belong. Hence, R-zones corresponding to each group can be recovered during recovery of RMD 600.

Furthermore, as recording of replacement data for LOW is allowed in only an R-zone included in the group to which the original data belongs, only recording blocks having an identical group code can be collected on the basis of the group information during recovery of a replacement entry of data to be reproduced. For example, when file system data is recovered, only recording blocks corresponding to group 0 are collected and accessed, so locations of replacement data of the file system data can be rapidly searched for.

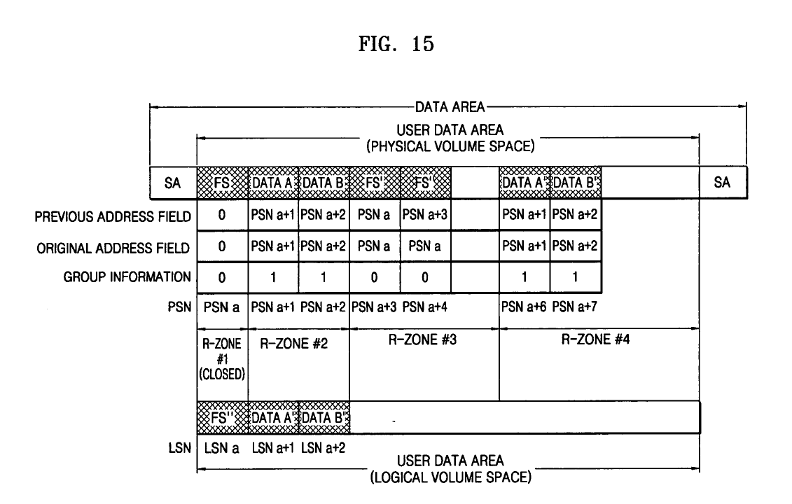

FIGS. 14 and 15 illustrate a structure of an information recording medium on which recording unit blocks has been recorded, according to an embodiment of the present invention. Similar to the above-described embodiment described with reference to FIG. 4 and FIGS. 9A through 9C, it is assumed that a user data area of the information recording medium is divided into two groups: group 0 for storing file system data and group 1 for storing user data. Referring to FIG. 15, when the host 240 commands a drive system 200 to write initial file system data FS to a Logical Sector Number (LSN) a, the drive system 200 writes the initial file system data FS to a Physical Sector Number (PSN) a on an information recording medium, which corresponds to LSN a. At this time, both values of a previous address field 1422 and an original address field 1421 included in the initial file system data FS are set to be 0 to indicate that the recording unit block 1400 corresponding to the initial file system data FS is an original block (namely, a block that is initially recorded and does not replace any block). The group information 1423 included in the initial file system data FS is set to be 0 because the initial file system data FS is associated with group 0.

Thereafter, the host 240 commands the drive system to write data A and data B to LSN a+1 and LSN a+2, respectively. The drive system 200 writes data A and data B to PSN a+1 and PSN a+2 on the information recording medium, which correspond to LSN a+1 and LSN a+2, respectively. At this time, both values of a previous address field 1421 and an original address field 1422 included in data A are set as the physical address of data A, that is, PSN a+1. Likewise, both values of a previous address field 1421 and an original address field 1422 included in data B are set as the physical address of data B, that is, PSN a+2. This is because data A and data B are both initially recorded. The group information included in data A and data B is set to be 1 because data A and data B are user data in the shown example.

A method of recording a replacement recording block will now be described. The recording of data A and data B requires the file system data FS to be updated, so the host 240 commands the drive system to write file system data FS′ to LSN a to update the file system data FS according to LOW. In response to this command, the drive system 200 writes file system data FS′ to an unrecorded area PSN a+3 on the information recording medium by knowing that the PSN a on the information recording medium corresponding to the LSN a has already been recorded with data. Also, the drive system generates replacement entry #1 to indicate that data recorded at PSN a has been replaced by data recorded at PSN a+3.

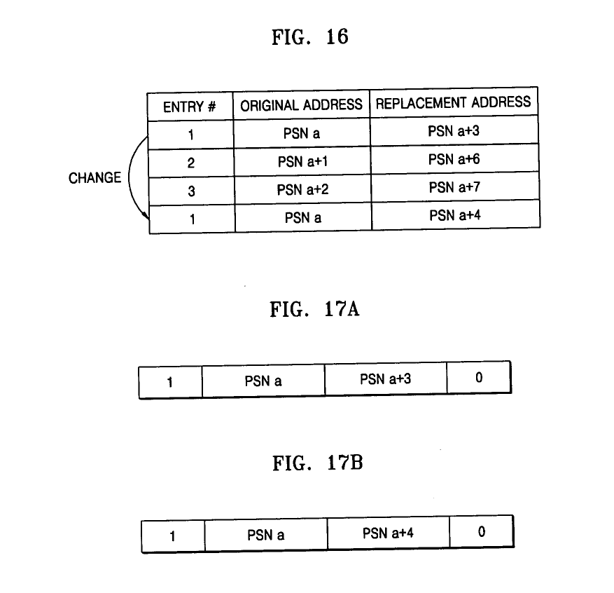

FIG. 16 shows replacement entry #1 in which PSN a is set as an original address and PSN a+3 is set as a replacement address.

Referring back to FIG. 15, values of a previous address field and an original address field in a replacement recording block recorded at PSN a+3, namely, file system data FS′, are set to PSN a to indicate that an immediately previous block of the replacement recording block is recorded at PSN a and that an original recording block for the replacement recording block is recorded at PSN a. The group information 1423 included in file system data FS′ is set to be 0 to indicate that a group to which the file system data FS′ belongs is group 0 for storing file system data.

Thereafter, to update data A and data B with data A′ and data B′ according to LOW, the host 240 commands the drive system 200 to write data A′ and data B′ to LSN a+1 and LSN a+2, respectively. Then, the drive system 200 writes data A′ and data B′ to unrecorded areas PSN a+6 and PSN a+7, respectively, on the information recording medium by knowing that PSN a+1 and PSN a+2 on the information recording medium corresponding to LSN a+1 and LSN a+2 have already been recorded with data.

Referring to FIG. 16, the drive system 200 generates replacement entry #2 to indicate that data recorded at PSN a+1 has been replaced by data recorded at PSN a+6 and replacement entry #3 to indicate that data recorded at PSN a+2 has been replaced by data recorded at PSN a+7.

Referring back to FIG. 15, values of a previous address field 1421 and an original address field 1422 in the replacement recording block recorded at PSN a+6, namely, data A′, are both set as PSN a+1. The group information 1423 included in data A′ is set to be 1 because data A′ is user data.

The updating of data A and data B requires file system data FS′ to be updated, so the host 240 commands the drive system 200 to write file system data FS″ to LSN a. In response to the command, the drive system 200 writes file system data FS″ to an unrecorded area PSN a+4 on the information recording medium by knowing that the PSN a on the information recording medium corresponding to the LSN a has already been recorded with data and knowing from replacement entry #1 that data recorded at PSN a has been replaced by data recorded at PSN a+3. Also, the drive system 200 changes replacement entry #1 to indicate that the data recorded at PSN a has been replaced by the data recorded at PSN a+4.

Referring to FIG. 16, a replacement address of replacement entry #1 is changed from PSN a+3 to PSN a+4. Referring back to FIG. 15, a value of a previous address field 1421 in the replacement recording block 1400 recorded at PSN a+4, namely, file system data FS″, is set to PSN a+3 to indicate that an immediately previous block of the replacement recording block is recorded at PSN a+3. A value of an original address field 1422 in the replacement recording block 1400 recorded at PSN a+4, namely, file system data FS″, is set to PSN a to indicate that a physical address corresponding to the logical address of file system data FS″ is PSN a. The group information 1423 included in file system data FS″ is set to be 0, which indicates group 0, because file system data FS″ is file system data.

A method of recovering a replacement entry will now be described. If an information recording medium on which data is recorded as described above is loaded again on the drive system 200, and the drive system 200 fails to obtain a final TDFL from a temporary defect management area 412 of a lead-in or lead-out area 410, 430 of the information recording medium 400, the drive system 200 needs to recover at least a replacement entry 510, which indicates a status of the information recording medium on which replacement required upon defect generation or replacement for LOW has occurred, among the TDFL 500. The replacement entry 510 is recovered using the values of a previous address field 1421 and an original address field 1422 included in an additional information part 1420 extracted from a recording block 1400 recorded on the information recording medium 400. In particular, in an aspect of the present invention, data recorded in a user data area 420 of the information recording medium is divided into groups according to the characteristics of data. Hence, if file system data is desired to be reproduced, the group information fields 1423 of the additional information parts 1420 of all recording unit blocks 1400 recorded on the information recording medium are first searched, and only recording unit blocks 1400 having group information fields 1423 filled with group 0 are collected. Thus, the time required to recover a replacement entry can be reduced.

An example of the reproduction of file system data will now be described with reference to FIGS. 15, 17A, and 17B. First, the drive system 200 accesses group information fields 1423 of additional information parts 1420 included in all the recording unit blocks 1400 recorded in the information recording medium, and reads out only recording unit blocks having group information fields 1423 filled with 0. Next, the drive system 200 reads out a recording block 1400 recorded at PSN a and detects from the “0” recorded in the previous address field 1421 and the original address 1422 field that the read-out recording block is initial file system data that is initially recorded as opposed to other data having a “1”. Then, the drive system 200 reads out a recording block recorded at PSN a+3 and knows from the PSN a recorded in a previous address field 1421 of the read-out recording block that the read-out recording block has replaced the recording block recorded at PSN a and from the PSN a recorded in an original address field 1422 of the read-out recording block that file system data recorded at PSN a+3 has a logical address corresponding to PSN a. According to this knowledge, the drive system 200 recovers replacement entry #1 of FIG. 17A, which indicates a status of the information recording medium on which data recorded at PSN a has been replaced by data recorded at PSN a+3.

Then, the drive system 200 reads out a recording block recorded at PSN a+4 and knows from PSN a+3 recorded in a previous address field 1421 of the read-out recording block 1400 that the read-out recording block 1400 has replaced a recording block 1400 recorded at PSN a+3 and from PSN a recorded in an original address field 1422 of the read-out recording block that the physical address of original data of the read-out recording block is PSN a. According to this knowledge, the drive system 200 changes the replacement address of the replacement entry #1 of FIG. 17A from PSN a+3 to PSN a+4 to recover replacement entry #1 of FIG. 17B. Because no more recording unit blocks 1400 having group information 1423 of 0 exist in the user data area of FIG. 15, the drive 200 detects that the recording unit block 1400 recorded at PSN a+4 is a final update of the initially recorded file system data.

As described above, correct replacement entry #1 of a recording block 1400 can be recovered using the previous address field 1421 and the original address field 1422 included in the additional information part 1420 of the recording block. In the above-described recovering method, a location of a final replacement recording block can be searched by referring to values recorded in previous address fields 1421 of the recording blocks having original address fields 1422 filled with identical values. Hence, an accurate replacement entry of the final replacement recording block can be recovered. In other words, the original address field 1422 of a recording block 1400 provides a value with which an original address field 1422 of a replacement entry for the recording block is filled. The previous address field 1421 of a recording block 1400 provides a value with which a replacement address field of a replacement entry for the recording block 1400 is filled. In particular, in an aspect of the present invention, group information 1423 is further included in such a recording unit block so that recovery of only data associated with a specific group can be rapidly performed.

According to an aspect of the present invention, a user data area of an information recording medium is divided into several groups determined according to the characteristics of data to be recorded. Data is recorded in different groups of the user data area according to the type of data. Thus, the efficiency of using the information recording medium can improve. For example, when a host wants to reproduce a final file system data from an information recording medium loaded on a drive system, the host can rapidly reproduce the final file system data by accessing only R-zones belonging to a group associated with file system data.

Furthermore, a recording unit block includes to-be-recorded data and information about a group to which the to-be-recorded data belongs. Hence, upon recovery of a replacement entry for the recording unit block, only R-zones that belong to the group can be accessed to search for an original address and a replacement address required to recover the replacement entry. Thus, the time required to recover the replacement entry can be reduced.

A data recording/reproducing method and a replacement entry recovering method as described above can also be embodied as computer readable codes on at least one computer readable recording medium for use with one or a plurality of special purposes and/or general purpose computers or controllers. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the data recording/reproducing method and the replacement entry recovering method can be easily construed by programmers skilled in the art to which the present invention pertains.

While described in terms of R-zones, RMD, and recording blocks, it is understood that other arrangements of data and areas can be utilizes with the present invention. Moreover, in addition to write once media using a logical overwrite method, it is understood that the present invention can be utilized in other methods beyond logical overwrite, for reasons other than logical overwrite, in rewriteable media, and in media beyond CD and DVD such as next generation optical media (e.g., Blu-ray and advanced optical discs) and in non-optical media.

While the present invention has been particularly shown and described with reference to exemplary embodiments thereof, it will be understood by those of ordinary skill in the art that various changes in form and details may be made therein without departing from the spirit and scope of the present invention as defined by the following claims and equivalents thereof.

What is claimed is:

1. An information recording medium with respect to which a recording and/or reproducing unit transfers data in recording blocks, the medium comprising:
a user data area for recording user data recorded in an original recording block and a replacement recording block, the user data area being divided into R-zones uniquely associated with corresponding different groups,
wherein:
the replacement recording block replaces the original recording block and was recorded in one of the R-zones having an unrecorded area, and
the replacement recording block is recorded by the apparatus in one of the R-zones which is associated with a same one of the groups associated with one of the R-zones having the original recording block.

2. The information recording medium of claim 1, wherein:
one of the groups indicates to the apparatus that the R-zones of the one group is for recording the user data, and
another one of the groups indicates to the apparatus that the R-zones of the another group is for recording file system data other than the user data.

3. The information recording medium of claim 1, further comprising recording management data (RMD) used by the apparatus to manage the recording of data on the information recording medium, wherein the RMD includes an RMD header that contains information indicating to the apparatus information about each the different groups and an R-zone entry that contains information indicating to the apparatus information about the R-zones.

4. The information recording medium of claim 3, wherein the RMD header includes:
information about a number of the groups,
information about a number of R-zones associated with each of the groups,
information about a number of open R-zones associated with each of the groups group, each of the open R-zones being an R-zone in which data can be written and which is other than a closed R-zone in which data cannot be written,
a list of R-zone entries for corresponding to each of the groups, or
combinations thereof.

5. The information recording medium of claim 3, wherein each of the R-zone entries includes information used by the apparatus to determine information about each of the groups, each of which is designated to a corresponding one or ones of the R-zones.

6. The information recording medium of claim 1, wherein each of the recording blocks includes:
a data part that contains original data or replacement data, and
an additional information part that contains additional information about the original data or the replacement data and group information which indicates to the apparatus which one of the groups is associated with the recording block.

7. A recording apparatus for use in transferring data in recording blocks with respect to an information recording medium comprising a user data area being divided into R-zones for recording user data, the R-zones being uniquely associated with corresponding different groups, the apparatus comprising:
a writing unit writing the data to the information recording medium; and
a controller which uniquely associates each of the R-zones with a corresponding one of the groups, and which controls the writing unit to
determine that a replacement recording block is to replace an original recording block previously recorded in the user data area, and
write the replacement recording block in one of the R-zones disposed in an unrecorded area of the user data area and having an indicated one of the groups which the controller has determined is the same as an R-zone having the original recording block.

8. The recording apparatus of claim 7, wherein:
one of the groups indicates that the group is for use in recording the user data, and
another one of the groups indicates that the group is for use in recording file system data other than the user data.

9. The recording apparatus of claim 7, wherein:
the controller provides recording management data (RMD) used to manage the recording of data on the information recording medium; and
the RMD includes an RMD header that contains information about each of the different groups and at least one R-zone entry that contains information about each of the R-zones.

10. The recording apparatus of claim 9, wherein the RMD header includes:
information about a number of the groups,
information about a number of R-zones associated with each of the groups,
information about a number of open R-zones for each of the groups, each of the open R-zones being an R-zone in which data can be written and which is other than a closed R-zone in which data cannot be written,
a list of R-zone entries for each of the groups, or
combinations thereof.

11. The recording apparatus of claim 9, wherein each of the R-zone entries includes information about which one of the groups is designated to each of the R-zones.

12. The recording apparatus of claim 7, wherein each of the recording blocks includes:
a data part that contains original data or replacement data, and
an additional information part that contains additional information about the original data or the replacement data, and group information about which one of the groups is associated with the recording block.

13. A reproducing apparatus which transfers data in recording blocks with respect to an information recording medium that comprises a user data area for recording user data, the user data area being divided into R-zones uniquely associated with corresponding different groups, the apparatus comprising:
a reading unit which reads data from the information recording medium in the recording blocks; and
a controller controlling the reading unit to read a replacement recording block from one of the R-zones which the controller determines is associated with a same group associated with one of the R-zones having the original recording block,
wherein the replacement recording block replaces the original recording block and is recorded in an area of the user data area which was previously an unrecorded area.

14. The reproducing apparatus of claim 13, wherein:
one of the groups is for recording user data type data, and
another one of the groups is for recording file system data type data other than the user data type.

15. The reproducing apparatus of claim 13, wherein:
the controller provides recording management data (RMD) used to manage the recording of the data in the information recording medium; and
the RMD includes an RMD header that contains information about the different groups, and at least one R-zone entry that contains information about the R-zones.

16. The reproducing apparatus of claim 15, wherein the RMD header includes:
information about a number of the different groups,
information about a number of R-zones associated with each of the groups,
information about a number of open R-zones for each of the groups, each of the open R-zones being an R-zone in which data can be written and which is other than a closed R-zone in which data cannot be written,
a list of R-zone entries for each of the groups, or
combinations thereof.

17. The reproducing apparatus of claim 15, wherein each of the R-zone entries includes information about which one of the groups is designated to each of the R-zones.

18. The reproducing apparatus of claim 13, wherein each of the recording blocks includes:
a data part that contains original data or replacement data, and
an additional information part that contains additional information about the original data or the replacement data and group information about which one of the groups is associated with the recording block.

19. A method of recording data in an information recording medium that comprises a user data area for recording data in recording blocks, the user data area being divided into R-zones uniquely associated with corresponding different groups and where a replacement recording block that replaces an original recording block recorded in the user data area is recorded in an unrecorded area of the user data area, the method comprising:
writing the replacement recording block in one of the R-zones associated with a same group as the group associated with the R-zone having the original recording block.

20. The method of claim 19, wherein:
one of the groups is for user data type of data, and
another one of the groups is for file system data type of data other than the user data type.

21. The method of claim 19, further comprising providing recording management data (RMD) used to manage the recording of data in the information recording medium, wherein the RMD includes an RMD header that contains information about each of the groups and at least one R-zone entry that contains information about each of the R-zones.

22. The method of claim 21, wherein the RMD header includes:
information about a number of the groups,
information about a number of the R-zones associated with each of the groups,
information about a number of open R-zones for each of the groups, each of the open R-zones being an R-zone in which data can be written and which is other than a closed R-zone in which data cannot be written,
a list of R-zone entries for each of the groups group, or
combinations thereof.

23. The method of claim 21, wherein each of the R-zone entries includes information about which one of the groups is designated to each of the R-zones.

24. The method of claim 19, wherein each of the recording blocks includes:
a data part that contains original data or replacement data, and
an additional information part that contains additional information about the original data or the replacement data and group information about which one of the groups is uniquely associated with the recording block.

25. A method of reproducing data from an information recording medium that comprises a user data area for recording data in recording blocks, the user data area being divided into R-zones uniquely associated with corresponding different groups and where a replacement recording block that replaces an original recording block recorded in the user data area is recorded in an unrecorded area of the user data area, the method comprising:
reading the replacement recording block from one of the R-zones associated with a same one of the groups associated with an R-zone having the original recording block.

26. The method of claim 25, wherein:
one of the groups is for recording user data, and
another one of the groups is for recording file system data other than the user data.

27. The method of claim 25, further comprising providing recording management data (RMD) used to manage the recording of the data on the information recording medium, wherein the RMD includes an RMD header that contains information about each of the groups and at least one R-zone entry that contains information about each of the R-zones.

28. The method of claim 27, wherein the RMD header includes:
information about a number of the groups,
information about a number of the R-zones associated with each group,
information about a number of open R-zones for each of the groups,
a list of R-zone entries for each of the groups, or
combinations thereof.

29. The method of claim 27, wherein each of the R-zone entries includes information about which one of the groups is designated to each of the R-zones.

30. The method of claim 25, wherein each of the recording blocks includes:
a data part that contains original data or replacement data, and
an additional information part that contains additional information about the original data or the replacement data, and group information about which one of the groups is uniquely associated with the recording block.

31. The method of claim 30, further comprising constructing recording management data (RMD) used to manage the recording of the data on the information recording medium according to the additional information part included in read ones of the recording blocks.

32. At least one computer readable medium encoded with processing instructions for implementing the method of recording data as recited in claim 19 using at least one computer.

33. At least one computer readable medium encoded with processing instructions for implementing the method of reproducing data as recited in claim 25 using at least one computer.

34. A method of managing data of different types on an information recording medium, comprising:
establishing a first area associated with a first group and a second area associated with a second group, the first group corresponding to a first type of the data previously recorded on the information recording medium and the second group corresponding to a second type of the data previously recorded on the information recording medium;
classifying new data to be recorded on the information recording medium according to whether the new data corresponds to the first type or the second type of previously recorded data;
if the new data corresponds to the first type of the previously recorded data, including the new data in the first group and recording the new data in the first area; and
if the new data corresponds to the second type of the previously recorded data, including the new data in the second group and recording the new data in the second area.

35. The method of claim 34, wherein:
the new data is included in the first group,
the first group is associated with a plurality of areas including the first area and in which data of the second group is not recorded, and
the previously recorded data of the first type is recorded in another one of the plurality of areas other than the first area.

36. The method of claim 34, wherein the new data is included in the first group, further comprising recording group data indicating that the new data is classified in the first group.

37. The method of claim 35, further comprising recording group data indicating that the new data is classified in the first group, indicating a number of the plurality of areas which are able to record additional data of the first type, and a number of the plurality of areas which are not able to record additional data of the first type.

38. The method of claim 37, further comprising:
if after recording the new data in the first area the first area cannot record additional data, updating the number of the plurality of areas which are able to record additional data of the first type, and the number of the plurality of areas which are not able to record additional data of the first type; and
further comprising, if after recording the new data in the first area the first area can record additional data, not updating the number of the plurality of areas which are able to record additional data of the first type, and the number of the plurality of areas which are not able to record additional data of the first type.

39. The method of claim 34, wherein the information recording medium comprises R-zones, and the method further comprises assigning ones of the R-zones including the first area to uniquely correspond to the first group and remaining ones of the R-zones including the second area to uniquely correspond to the second group.

40. The method of claim 34, wherein the new data comprises replacement data for the first type of previously recorded data.

41. The method of claim 34, wherein the first group corresponds to user data and the second group corresponds to file system data other than the user data.

42. The method of claim 35, further comprising:
if the plurality of areas associated with the first group cannot be written to, allocating a portion of the user data area not having data to be a new area of the first group, and writing the new data to the new area of the first group, and
if one the plurality of areas associated with the first group can be written to, writing the new data to the one area of the first group.

43. The method of claim 35, further comprising detecting positions of each of the plurality of areas associated with the first group and the second group using recorded position information for each of the areas.

44. The method of claim 34, further comprising recording group identification information in the new data indicating in to which of the first and second groups the new data is classified and which distinguish the classified new data from the other of the first and second groups.

45. The method of claim 44, further recording previous physical address information indicating an address of the previously recorded information being replaced by the new data.

46. At least one computer readable medium encoded with processing instructions for implementing the method of reproducing data as recited in claim 34 using at least one computer.

47. An information recording medium with respect to which a recording and/or reproducing unit transfers data in recording blocks, the medium comprising:
a data area being divided into first zones uniquely associated with a first group and second zones uniquely associated with a second group other than the first group,
wherein:
a first type of data associated with the first group is transferred with respect to the first zones and not with respect to the second zones,
a second type of data associated with the second group is transferred with respect to the second zones and not with respect to the first zones, and
group information on the information recording medium which distinguishes the first and second zones is used by the apparatus to determine with respect to which of the first and second zones the data is to be transferred.

48. The information recording medium of claim 47, wherein the first zones are non contiguous, and the medium further comprises address information used by the apparatus to detect a position of the first type of data of the first group which are recorded in the first zones.

49. A method of managing data of different types on an information recording medium having a first area associated with a first group and a second area associated with a second group, the first group corresponding to a first type of the data previously recorded on information recording medium and the second group corresponding to a second type of the data previously recorded on the information recording medium, the method comprising:
detecting first group information in a first recording block and classifying the first recording block in an indicated one of the first and second groups according to the first group information;
detecting second group information in a second recording block and classifying the second recording block in an indicated one of the first and second groups according to the second group information;
if the second group information indicates that the second recording block replaces the first recording block, recording management information indicating that the second recording block replaces the first recording block, and
if the second group information indicates that the second recording block does not replace the first recording block, recording management information indicating that the second recording block is in addition to the first recording block.

50. The method of claim 49, wherein:
the detecting the first group information comprises an original address and a replacement address of the first recording block, and
the detecting the second group information comprises another replacement address of the second recording block and the original address of the first recording block such that the second group information indicates that the second recording block replaces the first recording block.

51. At least one computer readable medium encoded with processing instructions for implementing the method of reproducing data as recited in claim 49 using at least one computer.

52. An apparatus which transfers data in recording blocks with respect to an information recording medium that comprises a user data area divided into zones uniquely associated with corresponding different groups, the apparatus comprising:
a transfer unit which transfers data with respect to the information recording medium in recording blocks; and
a controller which controls the transfer unit to transfer the recording blocks, detects group information, categorizes a first group of the recording blocks determined to be in the first group by the detected group information, categorizes a second group of the recording blocks determined to be in the second group by the detected group information, transfers the first group of recording blocks with respect to an associated first set of zones and not with respect to a second set of zones, and transfers the second group of recording blocks with respect to the second set of zones and not with respect to the first set of zones.

53. The apparatus of claim 52, wherein the controller further prepares a replacement recording block to replace an existing recording block, categorizes the replacement recording block to be included in a same group as the existing recording block, and records the replacement recording block in one of the zones uniquely associated with the group of the replacement recording block.

54. The apparatus of claim 52, wherein the controller further reads additional information in a read one of the recording blocks, and categorizes the read recording block in one of the first and second groups according to group information recorded in the additional information.
